(19) United States
(12) Patent Application Publication
(10) Pub. No.: US 2026/0003748 A1
(43) Pub. Date: Jan. 1, 2026

(54) STORAGE SYSTEM AND STORAGE SYSTEM CONTROL METHOD

(71) Applicant: Hitachi Vantara, Ltd., Yokohama-shi (JP)

(72) Inventors: Takafumi KIKUCHI, Tokyo (JP); Katsuto SATO, Tokyo (JP); Takahiro YAMAMOTO, Tokyo (JP)

(73) Assignee: Hitachi Vantara, Ltd., Yokohama-shi (JP)

(21) Appl. No.: 19/070,984

(22) Filed: Mar. 5, 2025

(30) Foreign Application Priority Data
Jun. 28, 2024 (JP) 2024-105337

(51) Int. Cl. G06F 11/20; G06F 11/14; G06F 11/16

(52) U.S. Cl. CPC G06F 11/2033; G06F 11/1441; G06F 11/1612

(57) ABSTRACT

The present invention has been made to reduce influence of maintenance events on performance. Disclosed is a storage system that includes a plurality of storage nodes, each having an arithmetic device and a memory. Upon detecting a failure of a separate storage node in the storage system, the plurality of storage nodes take over the failed storage node by failover. When a maintenance event occurs in the storage system, the plurality of storage nodes change, according to maintenance event information, conditions for detecting the failure of a storage node related to the maintenance event, and restrict data input/output processing. The maintenance event information is the information regarding the maintenance event.

### BACKGROUND OF THE INVENTION

### 1. Field of the Invention

The present invention relates to a storage system and a storage system control method.

### 2. Description of the Related Art

Some storage systems are known to be configured by connecting storage nodes running on computers by a network. In recent years, the storage systems are sometimes configured by using computing resources in a cloud computing environment.

When using the computing resources in a cloud computing environment, it is necessary to take into consideration the maintenance performed by a cloud vendor. Virtual machines, which are typical computing resources, may be forcibly terminated or rebooted. Technologies described, for example, in JP-2020-129184-A and JP-2023-151189-A can be used for maintenance of such circumstances.

JP-2020-129184-A states “availability is ensured in a cluster system while reducing operating costs through the use of an instance that may be forcibly terminated,” and that “a second server 30 is a server to which a service execution fails over in the event of a failure in the service execution at a first server 20, the second server 30 is a virtual server created in a cloud environment 50 as the instance of a first type that may be forcibly terminated by a cloud service provider, instance monitoring means 22 monitors whether the second server 30 is to be forcibly terminated, when it is detected that the second server 30 is to be forcibly terminated, instance operation means 23 causes the cloud environment 50 to create a third server 40 as the instance of the first type, and the instance operation means 23 causes the third server 40 to take over the functions provided by the second server 30.”

JP-2023-151189-A states that “a storage system is to be provided as being configured to achieve maintenance in accordance with a maintenance plan for a storage cluster, the maintenance leading to stable management of the storage cluster,” and that “a processor causes each of the plurality of servers to operate a storage node, combines a plurality of the storage nodes to set a storage cluster, performs a comparison between a maintenance plan for the storage cluster and a state of the storage cluster, so as to modify the maintenance plan based on a result of the comparison, and performs maintenance for the storage cluster in accordance with the maintenance plan modified.”

### SUMMARY OF THE INVENTION

The technology described in JP-2020-129184-A makes it possible to detect that a virtual machine is forcibly terminated, then to create a substitute virtual machine, and to allow the created substitute virtual machine to take over the functions. JP-2023-151189-A makes it possible to receive a maintenance plan for rebooting a virtual machine. In a case in which the storage system cannot accept the maintenance plan, it is possible to request a change in the maintenance plan. As described above, there are technologies for taking measures for maintenance performed by a cloud vendor. However, there are problems that cannot be solved by these technologies.

Some maintenances performed by cloud vendors do not reboot the virtual machine. In such a case, a central processing unit (CPU) and a network are temporarily stopped while the memory contents of the virtual machine are retained. When the CPU and the network are stopped, the storage node targeted for maintenance is unable to respond to a life/death monitoring function in the storage system and thus determined to have failed. Therefore, maintenance not involving a reboot requires measures such as stopping the target storage node in advance. However, simply stopping the storage node as a workaround will reduce the redundancy and the availability of the storage system. Further, since the maintenance not involving a reboot insignificantly affects the virtual machine, the relevant plan cannot be changed in most cases. That is, the above situation cannot be addressed by the plan change described in JP-2023-151189-A.

Meanwhile, the maintenance that reboots the virtual machine requires measures such as stopping the target storage node in advance. In such an instance, the number of operating storage nodes cannot be sufficient for the operation of the storage system. As a result, the storage system may come to an emergency stop, making it impossible to ensure data consistency.

As described above, in a case where maintenance is performed on the computing resources that form a storage system, performance is affected, for example, by decreased redundancy, reduced availability, and stoppage of the storage system.

In view of the above circumstances, an object of the present invention is to reduce influence on performance that is caused by maintenance events in a storage system.

In order to accomplish the above object, one representative storage system according to an aspect of the present invention includes a plurality of storage nodes, each having an arithmetic device and a memory. Upon detecting a failure of a separate storage node in the storage system, the plurality of storage nodes take over the failed storage node by failover. When a maintenance event occurs in the storage system, the plurality of storage nodes change, according to maintenance event information, conditions for detecting the failure of a storage node related to the maintenance event, and restrict data input/output processing, the maintenance event information being information regarding the maintenance event.

Further, one representative storage system control method according to another aspect of the present invention controls a storage system that includes a plurality of storage nodes, each having an arithmetic device and a memory. The storage system control method includes, when the plurality of storage nodes detect a failure of a separate storage node in the storage system, causing the plurality of storage nodes to take over the failed storage node by failover, and, when a maintenance event occurs in the storage system, causing the plurality of storage nodes to change, according to maintenance event information, conditions for detecting the failure of a storage node related to the maintenance event, and restrict data input/output processing, the maintenance event information being the information regarding maintenance event.

The present invention makes it possible to reduce influence on performance that is caused by maintenance events in a storage system. Problems, configurations, and advantages other than those described above will become apparent from the following description of embodiments.

### BRIEF DESCRIPTION OF THE DRAWINGS

FIG. 1 is a diagram illustrating a configuration of a storage system;

FIG. 2 is a diagram illustrating a network configuration of the storage system;

FIG. 3 is a diagram illustrating a hardware configuration of the storage system;

FIG. 4 is a diagram illustrating a configuration of an event monitoring mechanism;

FIG. 5 illustrates an event data table;

FIG. 6 is a flowchart illustrating an operation of the event monitoring mechanism;

FIG. 7 is a diagram illustrating a configuration of an event control mechanism according to a first embodiment;

FIG. 8 illustrates a resource information table and a capacity group information table;

FIG. 9 is a flowchart illustrating how control is exercised by the event control mechanism according to the first embodiment;

FIG. 10 is a flowchart illustrating how freeze event control is exercised by the event control mechanism;

FIG. 11 is a flowchart illustrating the end of control exercised by the event control mechanism according to the first embodiment;

FIG. 12 is a flowchart illustrating the end of freeze event control exercised by the event control mechanism;

FIG. 13 illustrates an example in which a storage cluster status under event control is displayed;

FIG. 14 is a diagram illustrating a configuration of the event control mechanism according to a second embodiment;

FIG. 15 illustrates a storage cluster information table group;

FIG. 16 is a flowchart illustrating how control is exercised by the event control mechanism according to the second embodiment;

FIG. 17 is a flowchart illustrating the end of control exercised by the event control mechanism according to the second embodiment;

FIG. 18 is a diagram illustrating a configuration of a frontend according to a third embodiment;

FIG. 19 illustrates a volume information table group; and

FIG. 20 is a flowchart illustrating I/O classification performed by the frontend according to the third embodiment.

### DESCRIPTION OF THE PREFERRED EMBODIMENTS

The present invention is implemented in a storage system that is configured by connecting storage nodes running on computers by a network.

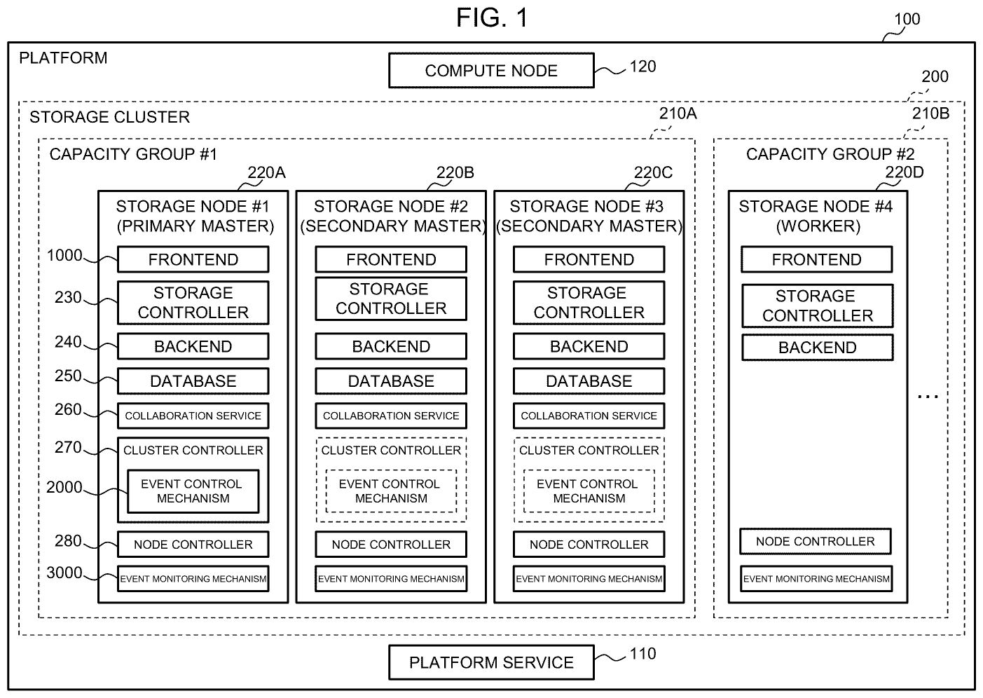

FIG. 1 is a diagram illustrating a configuration of the storage system. A platform service 110, a compute node 120, and a storage cluster 200 operate on a platform 100. The storage cluster 200 includes a plurality of storage nodes 220. The storage nodes 220 each include a frontend 1000, a storage controller 230, a backend 240, a database 250, a collaboration service 260, a cluster controller 270, a node controller 280, and an event monitoring mechanism 3000. Further, the cluster controller 270 includes an event control mechanism 2000.

The platform service 110 is a service for acquiring and controlling information regarding the platform 100 and may have a plurality of operation interfaces such as a command line interface and a representational state transfer application programming interface (REST API). The compute node 120 is an application that uses the storage cluster 200 and issues inputs/outputs (I/Os) to the storage nodes 220 through a network. The I/Os are requests for data input/output processing.

The plurality of storage nodes 220 form a capacity group 210. The capacity group 210 is a data protection group in the storage cluster 200. For example, a capacity group 210A (capacity group #1) includes a storage node 220A (storage node #1), a storage node 220B (storage node #2), and a storage node 220C (storage node #3). The storage controller and data are made redundant in these three storage nodes. The number of storage nodes 220 constituting the capacity group 210 may be set to any number, depending on the configuration of the storage system.

The storage nodes 220 are classified into several types. The storage node 220A (storage node #1) plays the role of a primary master, allows the cluster controller 270 to operate, and performs the function of controlling the storage cluster 200. The storage node 220B (storage node #2) and the storage node 220C (storage node #3) play the role of a secondary master and take over the function of controlling the storage cluster 200 when the storage node 220A (storage node #1) stops functioning. The cluster controller 270 in the secondary master waits in a standby state. The storage node 220D (storage node #4) plays the role of a worker. Unlike the primary and the secondary masters, the storage node 220D (storage node #4) does not provide services necessary for storage cluster management, such as the database 250, the collaboration service 260, and the cluster controller 270. Any number of storage nodes, such as primary masters, secondary masters, and workers, may be included, depending on the configuration of the storage system.

The frontend 1000 receives I/Os from the compute node 120, transfers the I/Os between the storage nodes 220 included in the storage cluster 200, and transfers the I/Os to the storage controller 230. The storage controller 230 processes the I/Os received from the frontend 1000. The storage controller 230 is configured in a redundant manner between the plurality of storage nodes 220. Therefore, even if one storage controller 230 comes to a stop, the storage controller 230 allows another storage controller 230 to take over the processing. The backend 240 provides data protection of the I/Os processed by the storage controller 230. Specifically, the backend 240 protects data by writing the data to a disk device external to the storage node 220. I/O data is made redundant between the plurality of storage nodes 220. Consequently, even if one storage node 220 comes to a stop, the I/O data can be restored from another storage node 220.

The database 250 stores configuration information and control information regarding the storage cluster 200. The database 250 operates as a distributed database between the plurality of storage nodes 220. The collaboration service 260 is responsible for collaborative processing between the storage nodes 220. For example, the collaboration service 260 monitors the life and death of the storage nodes 220, selects the primary master, namely, a leader, from the plurality of storage nodes 220, and conveys control information between the storage nodes 220. The cluster controller 270 controls the storage cluster 200. The node controller 280 performs intra-node control in each storage node 220.

The event monitoring mechanism 3000 acquires event information regarding each storage node 220 from the platform service 110 at regular intervals and delivers the event information to the event control mechanism 2000. On the basis of the information received from the event monitoring mechanism 3000, the event control mechanism 2000 determines and exercises the control required for the storage cluster 200.

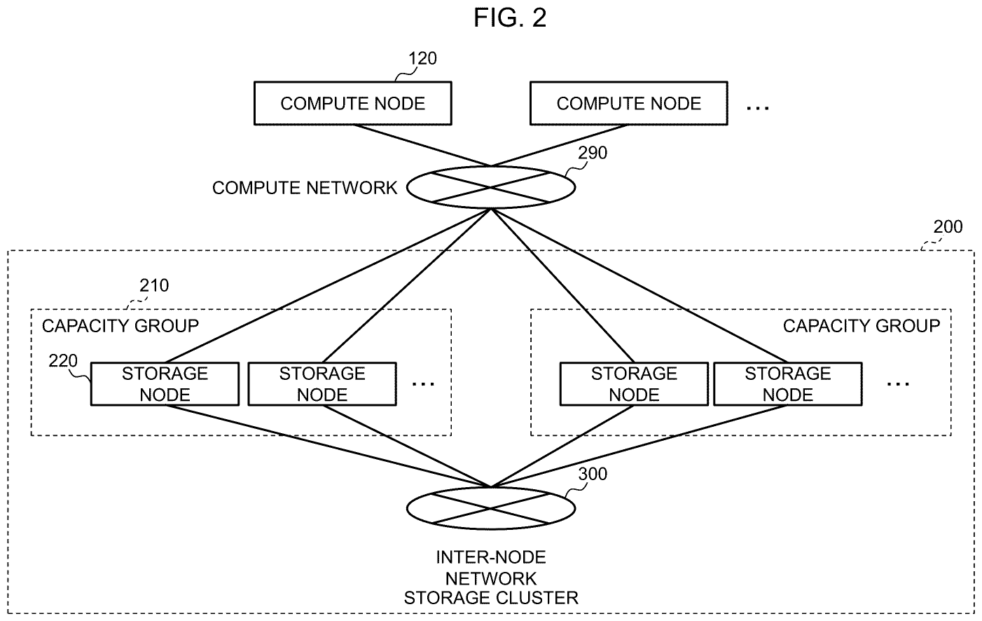

FIG. 2 is a diagram illustrating a network configuration of the storage system. The storage cluster 200 is configured such that the plurality of storage nodes 220 are connected by an inter-node network 300. The compute node 120 is connected to the plurality of storage nodes 220 by a compute network 290.

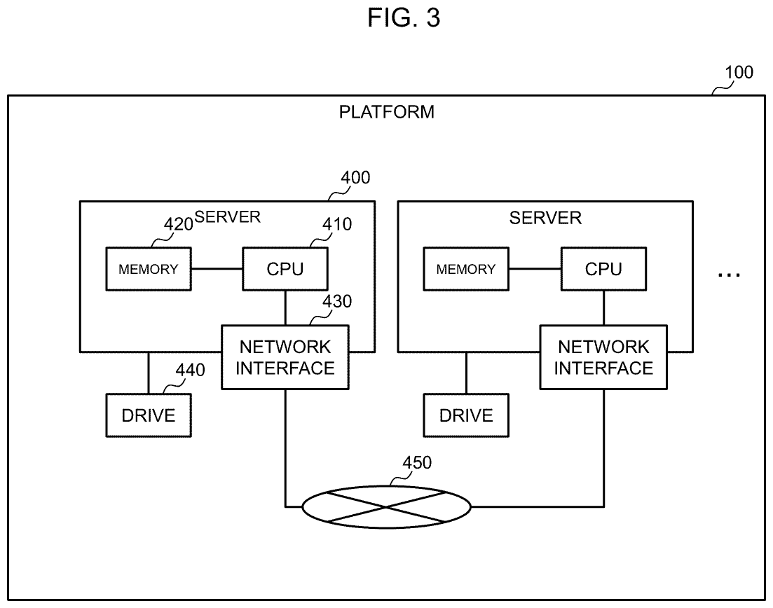

FIG. 3 is a diagram illustrating a hardware configuration of the storage system. A server 400 includes a CPU 410, a memory 420, a network interface 430, and a drive 440. The compute node 120 and the storage nodes 220 may be regarded as software that runs on the server 400. That is, when the CPU 410 executes a storage node control program, the server 400 functions as a storage node and executes a storage node control method. In this instance, computer resources as viewed from the compute node 120 and the storage nodes 220 may be physical resources or resources abstracted, for example, by a virtual machine. A plurality of the servers 400 are connected through a network 450. The platform 100 hosts the servers 400 and the network 450.

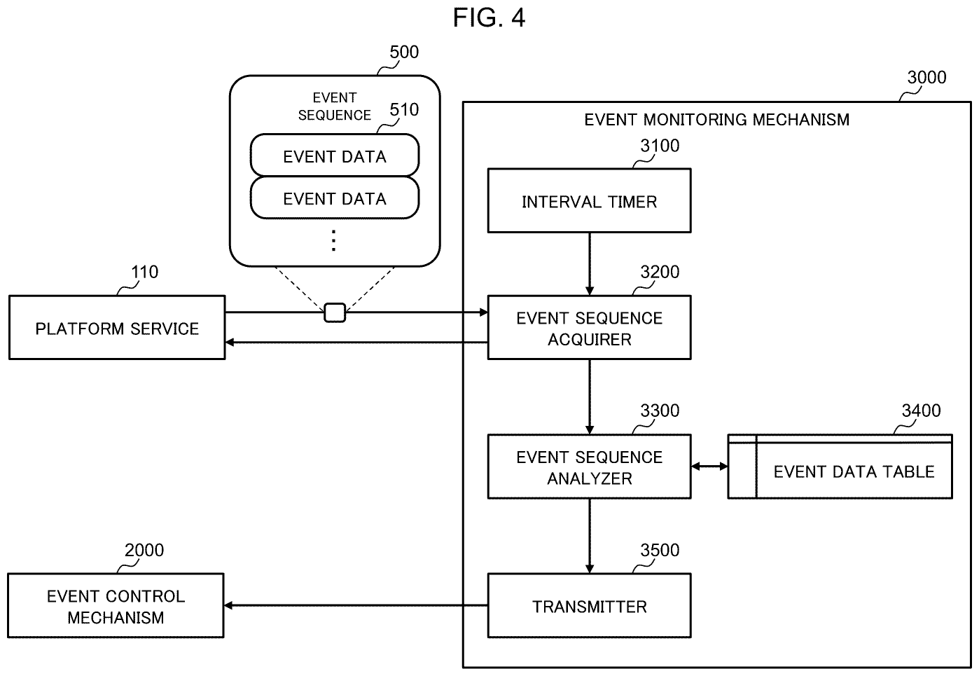

FIG. 4 is a diagram illustrating a configuration of the event monitoring mechanism. The event monitoring mechanism 3000 depicted in FIG. 1 includes an interval timer 3100, an event sequence acquirer 3200, an event sequence analyzer 3300, an event data table 3400, and a transmitter 3500.

The interval timer 3100 periodically starts the event sequence acquirer 3200 at regular intervals. The event sequence acquirer 3200 transmits an event information acquisition request to the platform service 110, and receives, as a response, an event sequence 500, whose element is event data 510.

The event sequence analyzer 3300 analyzes the event sequence 500 in collaboration with the event data table 3400. The event data table 3400 records information regarding the event sequence 500 acquired in the previous cycle. The event sequence analyzer 3300 compares contents of the event sequence 500 in the current cycle with those in the previous cycle to confirm whether an event targeted at the local node is scheduled or ended. In a case in which it is confirmed that the event targeted at the local node is either scheduled or ended, the event sequence analyzer 3300 passes the associated notification information to the transmitter 3500. Further, the event sequence analyzer 3300 overwrites the event data table 3400 with the contents of the event sequence 500 in the current cycle. Upon receiving a notification from the event sequence analyzer 3300, the transmitter 3500 transmits the contents of the notification addressed to the event control mechanism 2000.

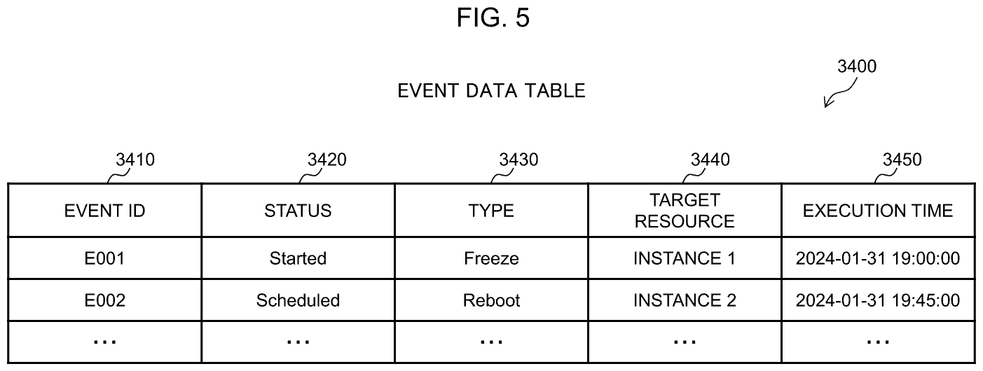

FIG. 5 illustrates the event data table. The event data table 3400 includes an event identification (ID) 3410, a status 3420, a type 3430, a target resource 3440, and an execution time 3450. These items of information are included in the event data 510, which is an element of the event sequence 500. The event data table 3400 records all the event data 510 received from the event sequence analyzer 3300.

The information regarding the event data 510 recorded in the event data table 3400 is maintenance information provided by the platform 100. An example of the method for recording the maintenance information will now be described with use of an example listed in the event data table 3400. An event of E001 with an event ID 3410 indicates that “a freeze event targeted at instance 1 is being executed.” The target resource 3440 is an event target resource name, namely, instance 1. The type 3430 is an event type indicating Freeze. Freeze indicates maintenance that does not require a reboot. The status 3420 is an event status indicating Started. Started indicates that the event is in an execution state. The execution time 3450 indicates the time when the event becomes executable. That is, the execution time 3450 of an event in the execution state indicates the time when execution started. The execution time 3450 of an event in the execution state may be another value such as “Started.” An event of E002 with an event ID 3410 indicates that “a reboot event targeted at instance 2 is scheduled to be executed.” The target resource 3440 is an event target resource name, namely, instance 2. The type 3430 is an event type indicating Reboot. Reboot indicates maintenance that requires a reboot. The status 3420 is an event status indicating Scheduled. Scheduled indicates that the event is scheduled to be executed. The execution time 3450 indicates the time when the event becomes executable. That is, the execution time 3450 of the event scheduled to be executed indicates the scheduled time to start execution.

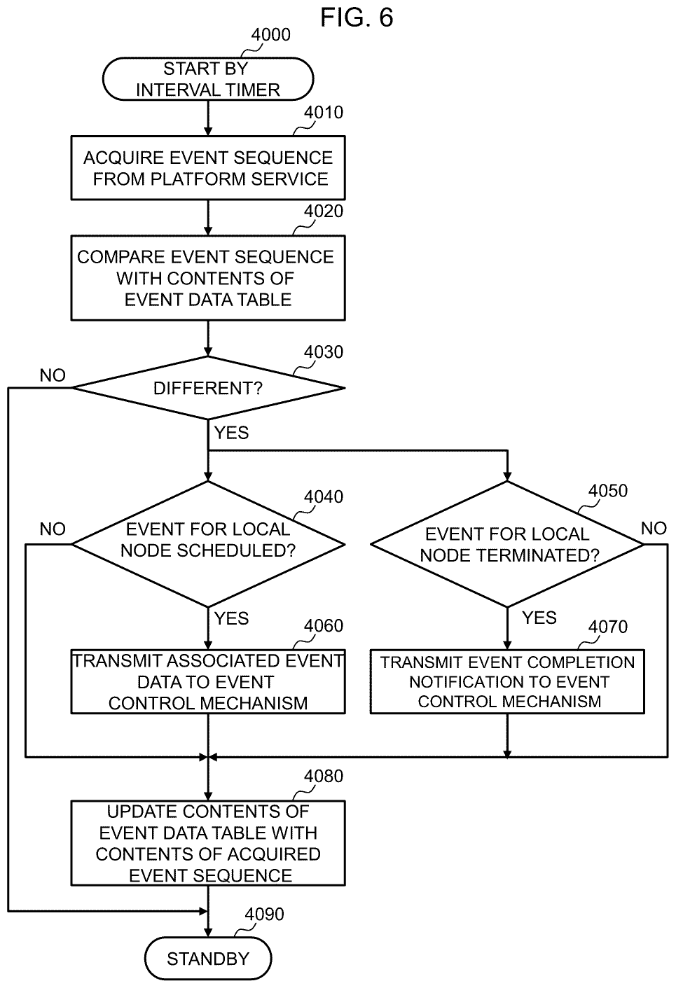

FIG. 6 is a flowchart illustrating an operation of the event monitoring mechanism. The event monitoring mechanism 3000 is started by the interval timer 3100 (step 4000). Then, the event monitoring mechanism 3000 acquires the event sequence 500 from the platform service 110 (step 4010). Next, the event monitoring mechanism 3000 compares the contents of the event sequence 500 with the contents of the event data table 3400 (step 4020) and determines whether their contents differ from each other (step 4030). If the answer to the query in step 4030 is YES, the processing proceeds to steps 4040 and 4050 where parallel processing can be performed. Meanwhile, if the answer is NO, the processing proceeds to step 4090.

If the answer to the query in step 4030 is YES, the event monitoring mechanism 3000 determines whether the event targeted at the local node is scheduled (step 4040). If the answer to the query in step 4040 is YES, the event monitoring mechanism 3000 transmits the event data 510 of the scheduled event to the event control mechanism 2000 (step 4060). Meanwhile, if the answer is NO, the processing proceeds to step 4080. The determination in step 4040 can be made by confirming that the event data 510 holds the contents in which the status 3420 is Scheduled (event execution is scheduled) and the target resource 3440 is a resource name indicating the local node.

If the answer to the query in step 4030 is YES, the event monitoring mechanism 3000 determines, in parallel with step 4040, whether the event targeted at the local node has ended (step 4050). If the answer to the query in step 4050 is YES, the event monitoring mechanism 3000 transmits an event completion notification 520 to the event control mechanism 2000 (step 4070). Meanwhile, if the answer is NO, the processing proceeds to step 4080. Here, the determination in step 4050 can be made by confirming that the event data 510 including the contents in which the status 3420 is Started (event being executed) and the target resource 3440 is a resource name indicating the local node, has disappeared.

Next, in step 4080, the event monitoring mechanism 3000 updates the contents of the event data table 3400 with the contents of the acquired event sequence 500. Finally, the event monitoring mechanism 3000 remains in the standby state until it is started again by the interval timer 3100 (step 4090).

As described above, the storage nodes 220 are able to monitor the schedule of events targeted at the local node and the end of events targeted at the local node by using the event monitoring mechanism 3000. Then, by exercising control to restrict I/O processing according to the results of event monitoring, it is possible to prevent a decrease in the redundancy and availability of the storage system and safely stop the storage nodes and the storage cluster.

### First Embodiment

A first embodiment of the present invention describes a method in which maintenance not requiring a reboot is handled without stopping the storage nodes. The present embodiment is implemented on the assumption that the adopted configuration is as depicted in FIGS. 1 to 6.

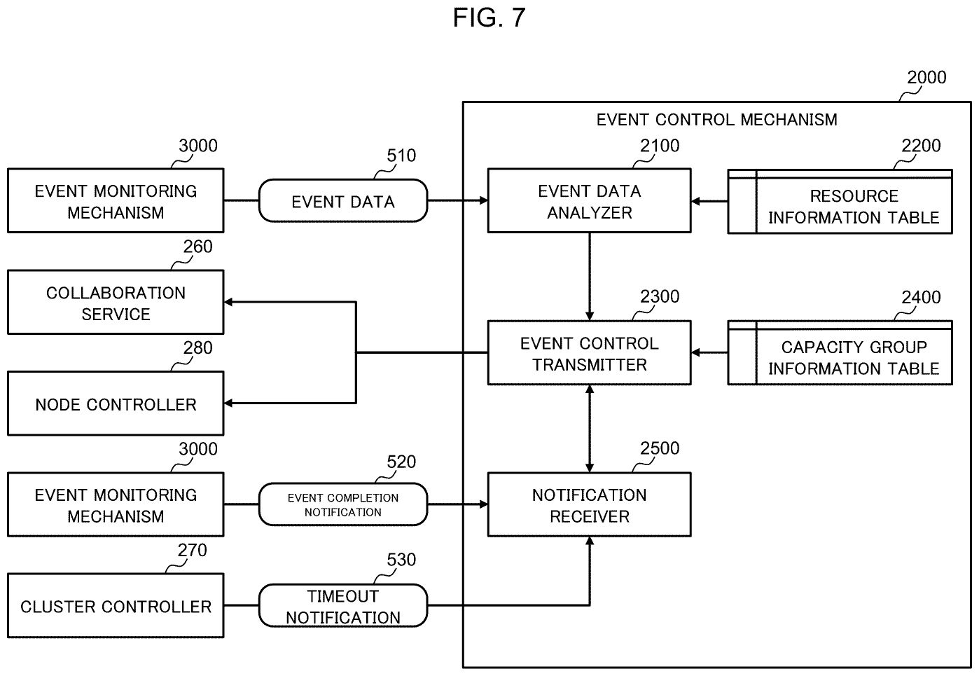

FIG. 7 is a diagram illustrating a configuration of the event control mechanism. The event control mechanism 2000 includes an event data analyzer 2100, a resource information table 2200, an event control transmitter 2300, a capacity group information table 2400, and a notification receiver 2500.

Upon receiving the event data 510 from the event monitoring mechanism 3000, the event data analyzer 2100 starts an operation. Then, from the event data 510 and the contents of the resource information table 2200, the event data analyzer 2100 identifies the ID of a storage node 220 that is targeted for control. Next, the event data analyzer 2100 confirms whether the type 3430 of the event data 510 is Freeze (maintenance not requiring a reboot). If the type 3430 of the event data 510 is a type other than Freeze, the event data analyzer 2100 ends the processing. Meanwhile, if the type is Freeze, the event data analyzer 2100 requests the event control transmitter 2300 to exercise control.

Upon receiving the above control request from the event data analyzer 2100, the event control transmitter 2300 starts an operation. Then, the event control transmitter 2300 requests the collaboration service 260 to extend a life/death monitoring timeout for the storage node 220 targeted for control. Next, from the capacity group information table 2400, the event control transmitter 2300 identifies the capacity group 210 to which the storage node 220 targeted for control belongs. Next, the event control transmitter 2300 acquires the IDs of all the storage nodes 220 belonging to the identified capacity group 210. Next, the event control transmitter 2300 requests the node controllers 280 of all the acquired storage nodes 220 to stop the reception of I/Os of the frontend 1000 and the issuance of asynchronous I/Os. Finally, the event control transmitter 2300 requests the notification receiver 2500 to stand by for notification addressed to the storage node 220 targeted for control. The asynchronous I/Os do not indicate data input/output processes to which a request is issued from the compute node 120, but indicate input/output processes to which a request is issued within the storage cluster 200. For example, the asynchronous I/Os indicate rebalancing processing for adjusting the amount of data stored in the plurality of storage nodes 220 and processing for creating a snapshot of stored data.

Upon receiving a request from the event control transmitter 2300, the notification receiver 2500 stands by for a notification. The notification receiver 2500 receives the event completion notification 520 from the event monitoring mechanism 3000 or a timeout notification 530 from the cluster controller 270. Upon receiving such a notification, the notification receiver 2500 confirms that the received notification is addressed to the storage node 220 targeted for control. If the received notification is addressed to such a target storage node 220, the notification receiver 2500 requests the event control transmitter 2300 to exercise control. If not, the notification receiver 2500 remains in standby for a notification.

Upon receiving a control request from the notification receiver 2500, the event control transmitter 2300 starts an operation. Then, the event control transmitter 2300 requests the collaboration service 260 to cancel the extension of the life/death monitoring timeout for the storage node 220 targeted for control. Next, from the capacity group information table 2400, the event control transmitter 2300 identifies the capacity group 210 to which the storage node 220 targeted for control belongs. Next, the event control transmitter 2300 acquires the IDs of all the storage nodes 220 belonging to the identified capacity group 210. Next, the event control transmitter 2300 requests the node controllers 280 of all the acquired storage nodes 220 to resume the reception of I/Os of the frontend 1000 and the issuance of asynchronous I/Os.

The effect of control exercised by the event control mechanism 2000 is described below. First of all, the effect of extending the life/death monitoring timeout for the storage nodes 220 will be described. Due to maintenance, the network of the storage nodes 220 is prevented from temporarily stopping due to maintenance and causing a timeout. This makes it possible to avoid a situation where the storage nodes 220 are determined to have failed due to maintenance. In this instance, the time by which the life/death monitoring timeout is to be extended is set to be longer than the execution time of maintenance. However, in order to reduce influence on the life/death monitoring of the storage cluster 200, the length of time of extension should not be extremely increased. Further, even if the timeout is extended, the life/death monitoring may still time-out, in which case the timeout notification is received from the cluster controller 270.

The effect of stopping the reception of I/Os of the frontend 1000 and stopping the issuance of asynchronous I/Os with respect to the storage nodes 220 belonging to the capacity group 210 will now be described. Due to maintenance, the network of the storage nodes 220 is prevented from temporarily stopping and causing the I/O processing to time out. Additionally, the capacity group 210 is a data protection group in the storage cluster 200 and configured to make the storage controller 230 and data redundant. Therefore, the storage nodes 220 belonging to the same capacity group 210 require inter-node communication to process I/Os. The inter-node communication can be suppressed by stopping the reception of I/Os of the frontend 1000 and stopping the issuance of asynchronous I/Os.

Further, the method for stopping the reception of I/Os of the frontend 1000 can be implemented by queuing the I/Os in a memory within the frontend 1000. I/O requests received while the reception of I/Os is stopped are stored in a queue and held without being processed. After the reception of I/Os is resumed, the I/Os stored in the queue are sequentially processed again. I/Os received before the stoppage of reception of I/Os will be processed until completion.

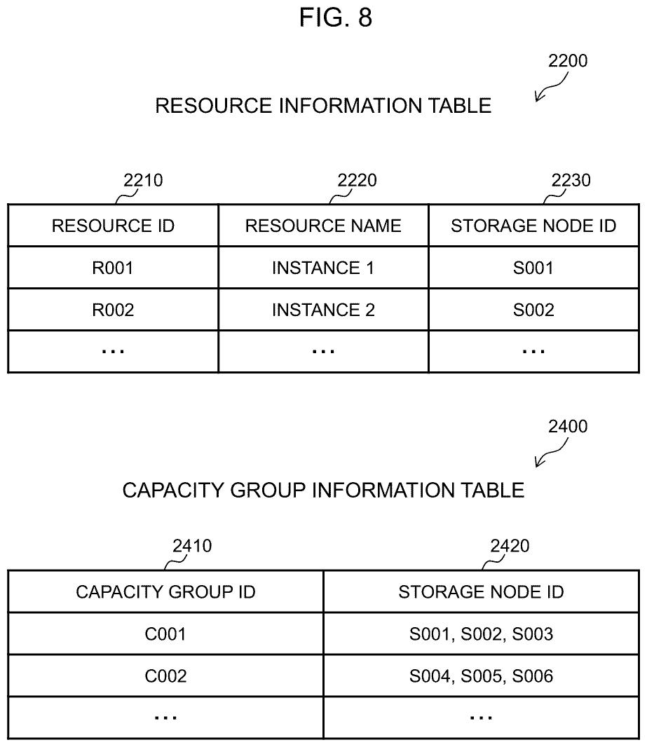

FIG. 8 illustrates the resource information table and the capacity group information table. The resource information table 2200 includes a resource ID 2210, a resource name 2220, and a storage node ID 2230. The resource information table 2200 indicates the correspondence between management information regarding the platform 100 and node management information regarding the storage cluster 200. The resource ID 2210 and the resource name 2220 are pieces of information managed by the platform 100 and can be acquired from the platform service 110. The storage node ID 2230 is the ID of a storage node 220.

The capacity group information table 2400 indicates a capacity group ID 2410 and a storage node ID 2420. The capacity group information table 2400 presents a list of the storage nodes 220 included in a capacity group 210. The capacity group ID 2410 is the ID of the capacity group 210. The storage node ID 2420 provides a list of the IDs of the storage nodes 220 included in each capacity group 210.

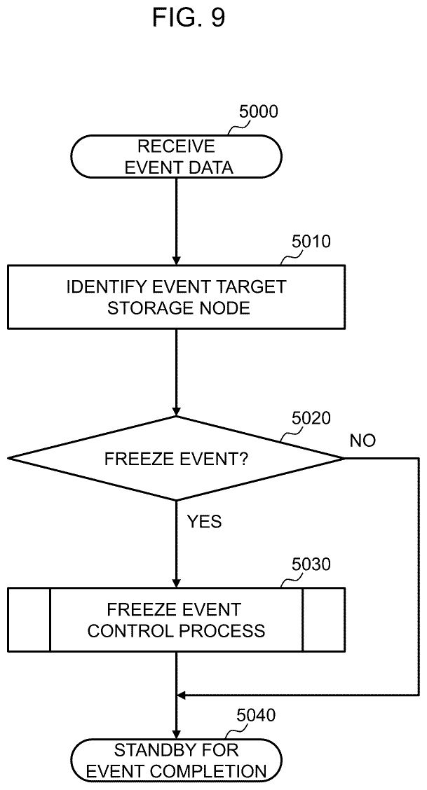

FIG. 9 is a flowchart illustrating how control is exercised by the event control mechanism according to the first embodiment. Upon receiving the event data 510 from the event monitoring mechanism 3000, the event control mechanism 2000 starts (step 5000). Next, from the contents of the event data 510, the event control mechanism 2000 identifies an event target storage node 220 (step 5010). Next, according to the contents of the event data 510, the event control mechanism 2000 determines whether a freeze event is targeted (step 5020). If the answer to the query in step 5020 is YES, the event control mechanism 2000 performs a freeze event control process (step 5030), and then the processing proceeds to step 5040.

Meanwhile, if the answer is NO, the processing proceeds to step 5040. In step 5040, the event control mechanism 2000 enters a state of standing by for event completion.

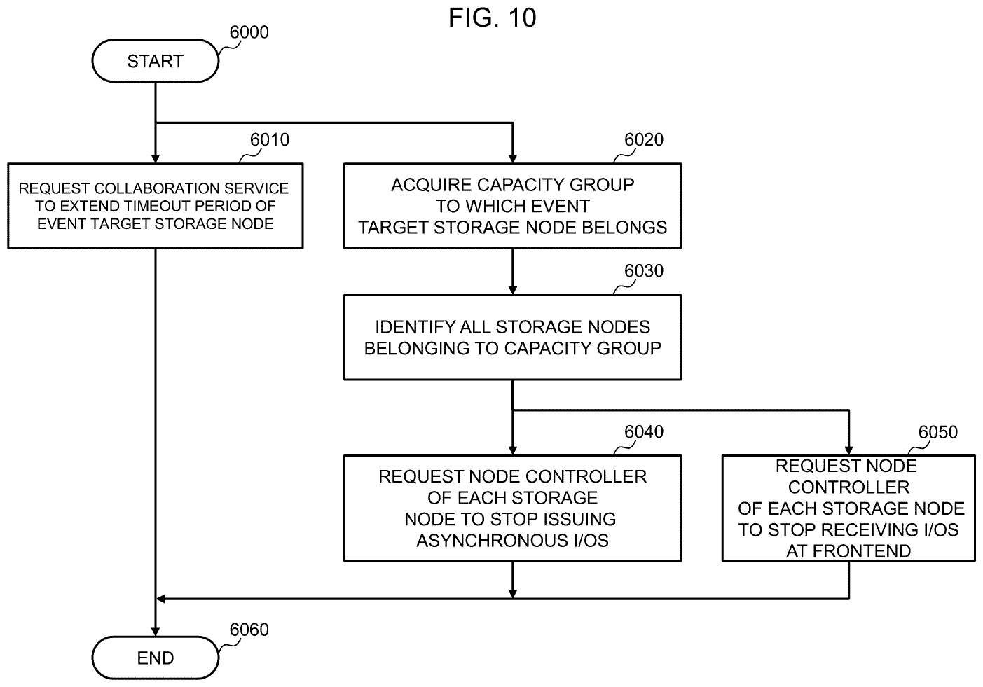

FIG. 10 is a flowchart illustrating how freeze event control is exercised by the event control mechanism 2000. This flowchart corresponds to the freeze event control process (step 5030) depicted in FIG. 9. When the freeze event control process starts (step 6000), the processing proceeds to steps 6010 and 6020 where parallel processing is possible.

In step 6010, the event control mechanism 2000 requests the collaboration service 260 to extend the timeout period of the event target storage node 220. Upon completion of step 6010, the processing proceeds to step 6060. In step 6020, the event control mechanism 2000 acquires a capacity group 210 to which the event target storage node 220 belongs. Next, the event control mechanism 2000 identifies all the storage nodes 220 belonging to the capacity group 210 (step 6030). Subsequently, the processing proceeds to steps 6040 and 6050 where parallel processing is possible.

In step 6040, the event control mechanism 2000 requests the node controller 280 of each storage node 220 to stop the issuance of asynchronous I/Os. Upon receiving such a request, the node controller 280 exercises control in such a manner that the storage controller 230 stops the issuance of asynchronous I/Os. In step 6050, the event control mechanism 2000 requests the node controller 280 of each storage node 220 to stop the reception of I/Os in the frontend 1000. Finally, after steps 6010, 6040, and 6050 are performed, the freeze event control process ends (step 6060).

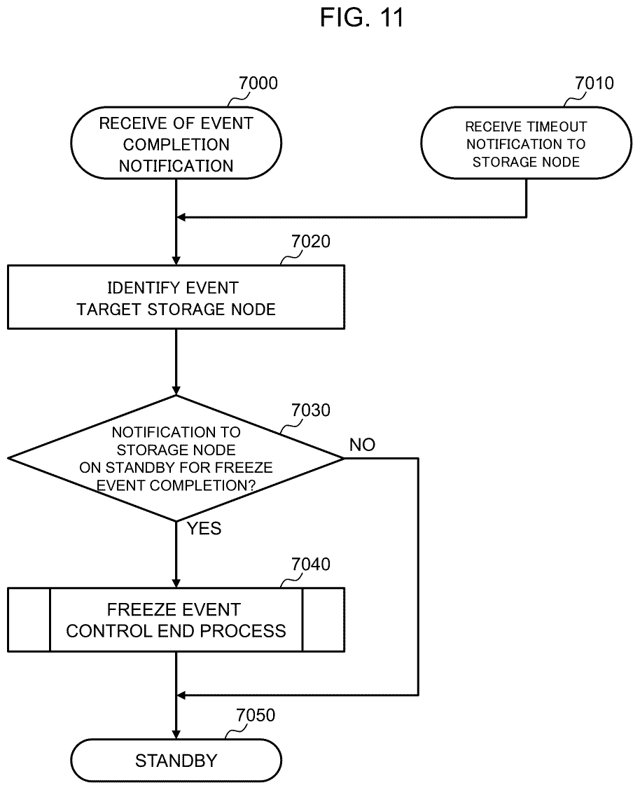

FIG. 11 is a flowchart illustrating the end of control exercised by the event control mechanism according to the first embodiment. Upon receiving the event completion notification 520 from the event monitoring mechanism 3000 (step 7000) or receiving the timeout notification 530 from the cluster controller 270 (step 7010), the event control mechanism 2000 starts to exercise control. Then, from the contents of the event data 510, the event control mechanism 2000 identifies the event target storage node 220 (step 7020). Next, according to the contents of the received notification, the event control mechanism 2000 determines whether the notification is addressed to a storage node 220 that is standing by for the completion of a freeze event (step 7030). If the answer to the query in step 7030 is YES, the event control mechanism 2000 performs a freeze event control end process (step 7040), and then the processing proceeds to step 7050. Meanwhile, if the answer is NO, the processing proceeds to step 7050. In step 7050, the event control mechanism 2000 enters a state of standing by for notification reception.

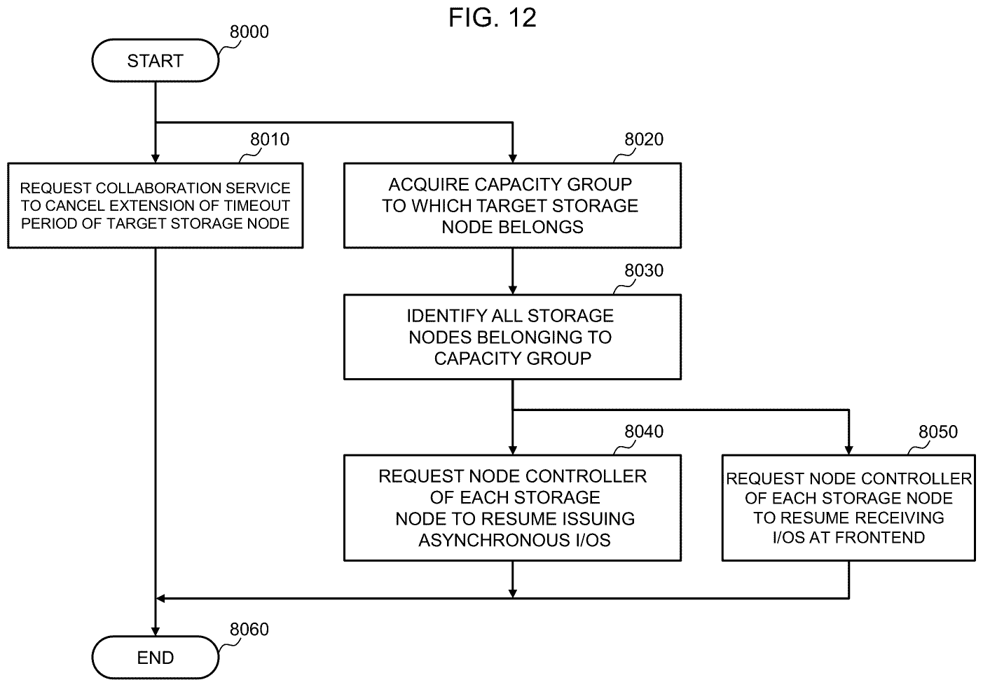

FIG. 12 is a flowchart illustrating the end of freeze event control exercised by the event control mechanism. This flowchart corresponds to the freeze event control end process (step 7040) depicted in FIG. 11. When the event control mechanism 2000 starts to exercise control (step 8000), the processing proceeds to steps 8010 and 8020 where parallel processing is possible.

In step 8010, the event control mechanism 2000 requests the collaboration service 260 to cancel the extension of the timeout period of the event target storage node 220. In step 8020, the event control mechanism 2000 acquires the capacity group 210 to which the event target storage node 220 belongs. Next, the event control mechanism 2000 identifies all the storage nodes 220 belonging to the capacity group 210 (step 8030). Next, the processing proceeds to steps 8040 and 8050 where parallel processing is possible.

In step 8040, the event control mechanism 2000 requests the node controller 280 of each storage node 220 to resume the issuance of asynchronous I/Os. In step 8050, the event control mechanism 2000 requests the node controller 280 of each storage node 220 to resume the reception of I/Os in the frontend 1000. Finally, after steps 8010, 8040, and 8050 are performed, the freeze event control end process ends (step 8060).

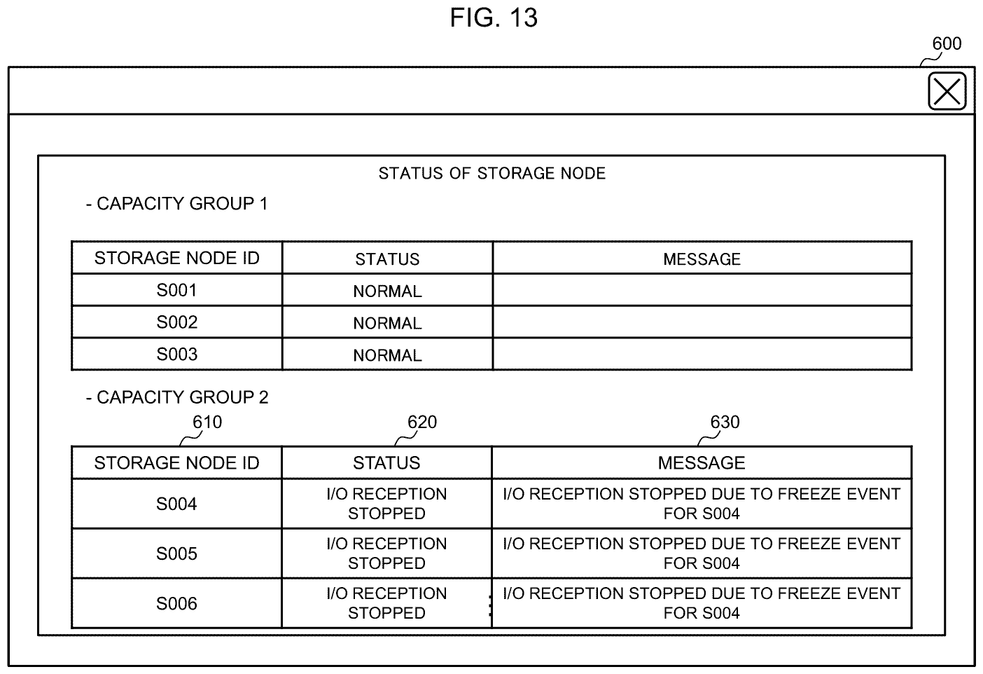

FIG. 13 illustrates an example in which a storage cluster status under event control is displayed. A management screen 600 displays information regarding the storage cluster 200, and appears, for example, on a display connected to the storage cluster 200 through a network. The management screen 600 depicted in FIG. 13 is an example of displaying the status of the storage nodes 220 belonging to each capacity group 210.

The status of a storage node 220 on the management screen 600 includes a storage node ID 610, a status 620, and a message 630. These items of information enable a user to confirm the status of each storage node 220 and the factors contributing to that status. For example, for a storage node 220 displayed on the management screen 600, a state such as “Normal” or “I/O reception stopped” can be displayed as the status 620. When “I/O reception stopped” is displayed as the status 620, it indicates that freeze event control is being exercised by the event control mechanism 2000. Further, the message 630 enables the user to confirm which storage node 220 is involved in a freeze event and has stopped receiving I/Os.

As described above, when a freeze event occurs, the first embodiment makes it possible to extend the timeout period of the event target storage node, stop the issuance of asynchronous I/Os in the capacity group to which the event target storage node belongs, and stop the reception of I/Os, thereby preventing the storage node from being stopped.

### Second Embodiment

A second embodiment of the present invention describes a method in which a control method for maintenance is determined and executed in consideration of information regarding the storage cluster 200. The second embodiment is described below in a form that is based on the configuration depicted in FIGS. 1 to 6 and obtained by extending the first embodiment. However, it should be noted that the purpose of the second embodiment is to determine the control method for maintenance in consideration of the information regarding the storage cluster 200. Therefore, the second embodiment need not be restricted to the form of the first embodiment.

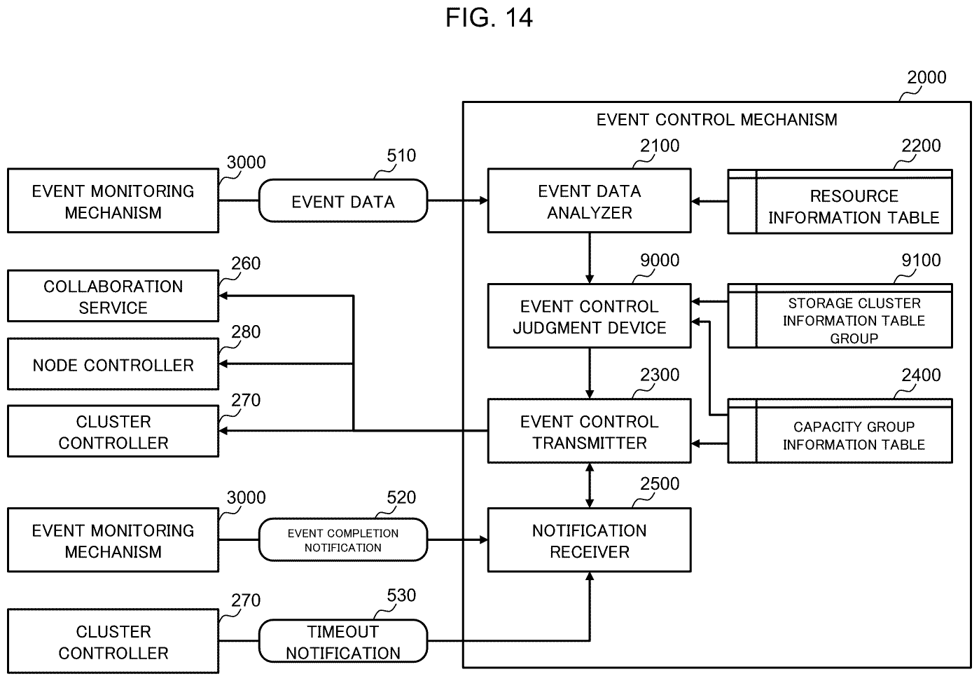

FIG. 14 is a diagram illustrating a configuration of the event control mechanism according to the second embodiment. The event control mechanism 2000 includes the event data analyzer 2100, the resource information table 2200, an event control judgment device 9000, a storage cluster information table group 9100, the event control transmitter 2300, the capacity group information table 2400, and the notification receiver 2500.

Upon receiving the event data 510 from the event monitoring mechanism 3000, the event data analyzer 2100 starts an operation. Next, according to the contents of the event data 510 and resource information table 2200, the event data analyzer 2100 identifies the ID of a storage node 220 that is targeted for control.

Next, the event data analyzer 2100 confirms whether the type 3430 of the event data 510 is Freeze (maintenance not requiring a reboot) or Reboot (maintenance requiring a reboot). If the type is neither Freeze nor Reboot, the event data analyzer 2100 ends the processing. Meanwhile, if the type is Freeze or Reboot, the event data analyzer 2100 requests the event control judgment device 9000 to make a control judgment.

Upon receiving a control judgment request from the event data analyzer 2100, the event control judgment device 9000 starts an operation. Then, in a case where a freeze event is scheduled to be executed in the storage node 220 targeted for control, the event control judgment device 9000 judges whether the freeze event control process (step 5020) can be performed. If it is judged that the freeze event control process can be performed, the event control judgment device 9000 requests the event control transmitter 2300 to perform the freeze event control process (step 5020). Meanwhile, if it is judged that the freeze event control process (step 5020) cannot be performed, the event control judgment device 9000 judges that a blockage process needs to be performed on the storage node 220. Also in a case where a reboot event is scheduled to be executed in the storage node 220 targeted for control, the event control judgment device 9000 also judges that the blockage process needs to be performed on the storage node 220.

Next, the event control judgment device 9000 makes a judgment regarding the blockage process on the storage node 220. On the basis of the information in the storage cluster information table group 9100 and the capacity group information table 2400, the event control judgment device 9000 judges whether blocking the storage node 220 will cause a failure exceeding the redundancy of the storage cluster 200. If it is judged that a failure exceeding the redundancy of the storage cluster 200 will occur, the event control judgment device 9000 requests the event control transmitter 2300 to perform the blockage process on the storage cluster 200. If not, the event control judgment device 9000 requests the event control transmitter 2300 to perform the blockage process on the storage node 220.

Upon receiving a control request from the event control judgment device 9000, the event control transmitter 2300 starts an operation. Then, the event control transmitter 2300 exercises control according to the contents of the control requested by the event control judgment device 9000. When requested to perform a freeze event control process 5020, the event control transmitter 2300 exercises control exactly in the manner described with reference to FIGS. 7 and 10. When requested to perform the blockage process on the storage cluster 200, the event control transmitter 2300 requests the cluster controller 270 to perform such a process, and then the processing ends. When requested to perform the blockage process on the storage node 220, the event control transmitter 2300 requests the node controller 280 to perform such a process. Finally, the event control transmitter 2300 requests the notification receiver 2500 to stand by for a notification addressed to the storage node 220 targeted for control.

Upon receiving a request from the event control transmitter 2300, the notification receiver 2500 stands by for a notification. The notification receiver 2500 receives the event completion notification 520 from the event monitoring mechanism 3000 or receives the timeout notification 530 from the cluster controller 270. Upon receiving the notification, the notification receiver 2500 confirms whether the notification is addressed to the storage node 220 targeted for control. If the notification is addressed to the storage node 220 targeted for control, the notification receiver 2500 requests the event control transmitter 2300 to exercise control. If not, the notification receiver 2500 remains in standby for a notification.

The event control transmitter 2300 also starts an operation upon receiving a control request from the notification receiver 2500. In the case of a notification addressed to a storage node 220 that has performed the freeze event control process, the event control transmitter 2300 performs the freeze event control end process (step 7040) in which control is exercised exactly in the manner described with reference to FIGS. 7 and 12. Meanwhile, in the case of a notification addressed to a storage node 220 on which a node blockage process has been performed, the event control transmitter 2300 requests the cluster controller 270 to perform a node restoration process.

A supplementary explanation of control performed by the event control mechanism 2000 will now be given. First, an example cited below indicates a case where factors for determining whether or not the freeze event control process (step 5020) can be performed relate to a situation in which the grace period before freeze event execution is shorter than the processing time required for the freeze event control process (step 5020). A situation where the freeze event control process (step 5020) cannot be executed will be handled by performing the blockage process on the storage node 220.

Next, the blockage process on the storage node 220 is to stop the processing performed on a target node, restart the target node, and place the target node in a standby state. Blocking the storage node 220 prevents the storage cluster 200 from being affected by maintenance. In this instance, for example, the I/O processing to be performed by the blocked storage node 220 is temporarily taken over by another storage node 220. Further, the blocked storage node 220 can be returned to the storage cluster 200 by a restoration process performed by the cluster controller 270.

Finally, the blockage process on the storage cluster 200 is to stop the storage cluster 200. This process needs to be performed in the event of a failure exceeding the redundancy at which the storage cluster 200 is able to continue to operate. The determination of whether the storage cluster 200 is able to continue to operate can be made, for example, according to the number of storage nodes 220 and the number of failed drives 440 used by the storage nodes 220. If the number of failed units in the capacity group 210 exceeds the redundancy of the storage cluster 200, a continuous operation cannot be performed. The blockage process on the storage cluster 200 is able to stop the storage cluster 200 before the occurrence of a failure exceeding the redundancy.

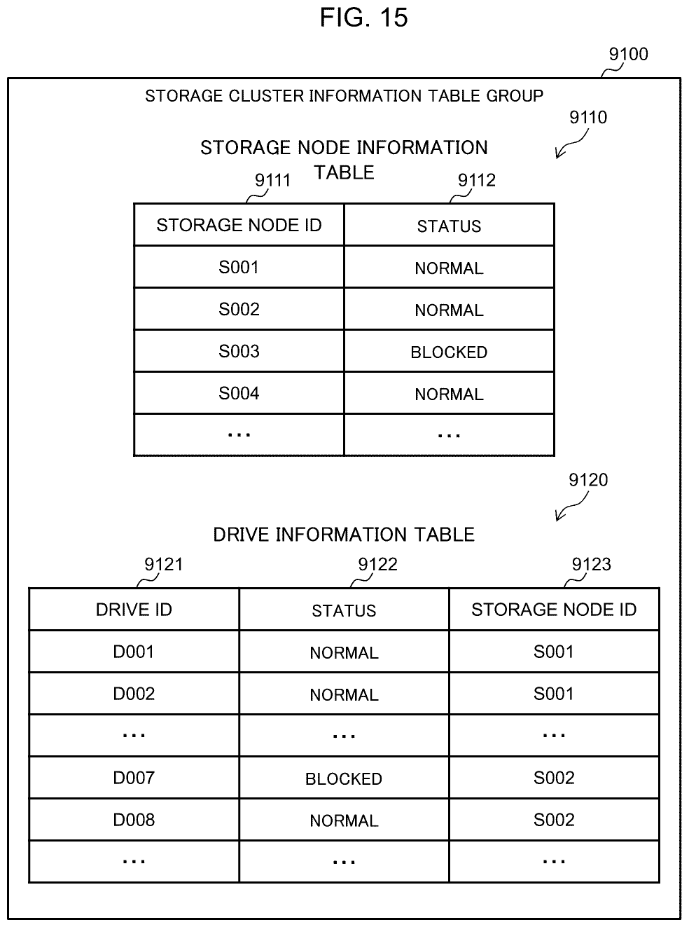

FIG. 15 illustrates the storage cluster information table group. The storage cluster information table group 9100 includes a storage node information table 9110 and a drive information table 9120. The storage node information table 9110 includes a storage node ID 9111 and a status 9112. The drive information table 9120 includes a drive ID 9121, a status 9122, and a storage node ID 9123. Information in the storage cluster information table group 9100 is acquired from the information regarding the storage cluster 200 managed in the database 250.

The storage node information table 9110 indicates the status of each storage node 220. If the status 9112 is “Normal,” the storage node 220 is operating normally. If the status 9112 is “Blocked,” the storage node 220 can be determined to have failed.

The drive information table 9120 indicates the status of each drive 440. If the status 9122 is “Normal,” the drive 440 is operating normally. If the status 9122 is “Blocked,” it can be determined that the drive 440 has failed. Further, confirming the storage node ID 9123 makes it possible to identify the storage node 220 to which each drive 440 belongs.

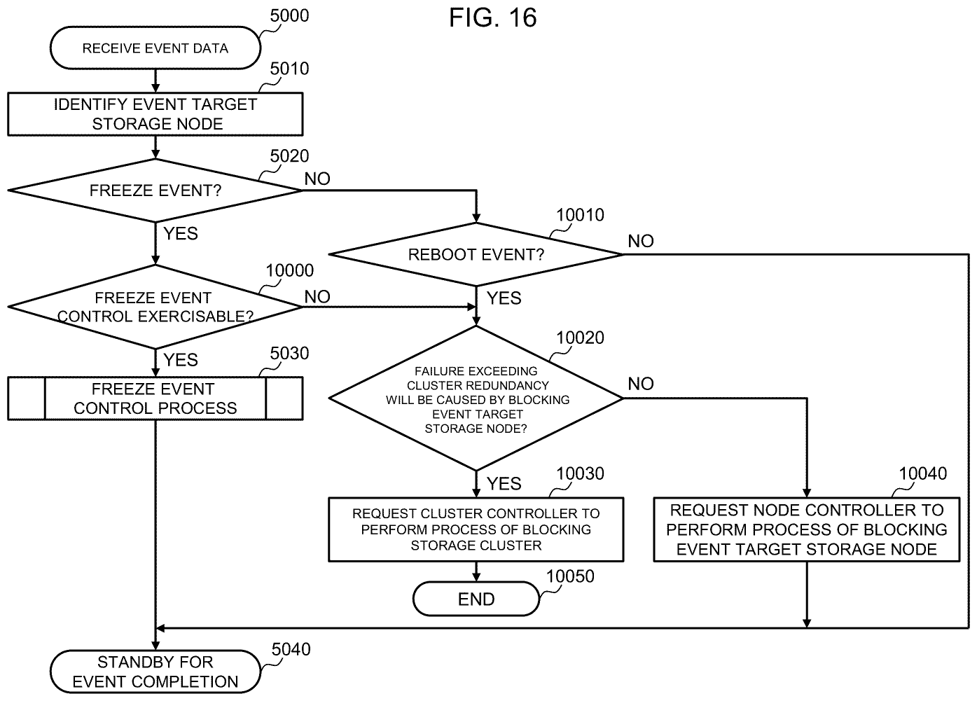

FIG. 16 is a flowchart illustrating how control is exercised by the event control mechanism according to the second embodiment. Upon receiving the event data 510 from the event monitoring mechanism 3000, the event control mechanism 2000 starts (step 5000). Then, from the contents of the event data 510, the event control mechanism 2000 identifies the event target storage node 220 (step 5010). Next, according to the contents of the event data 510, the event control mechanism 2000 determines whether a freeze event is targeted (step 5020). If the answer to the query in step 5020 is YES, the processing proceeds to step 10000. Meanwhile, if the answer is NO, the processing proceeds to step 10010.

In step 10000, the event control mechanism 2000 determines whether freeze event control can be exercised. If the answer to the query in step 10000 is YES, the event control mechanism 2000 performs the freeze event control process (step 5030), and stands by for event completion (step 5040). Meanwhile, if the answer is NO, the processing proceeds to step 10020. In step 10010, the event control mechanism 2000 determines whether a reboot event is targeted. If the answer to the query in step 10010 is YES, the processing proceeds to step 10020. Meanwhile, if the answer is NO, the event control mechanism 2000 stands by for event completion (step 5040).

In step 10020, the event control mechanism 2000 determines whether blocking the event target storage node 220 will cause a failure exceeding the redundancy of the storage cluster 200. If the answer to the query in step 10020 is YES, the event control mechanism 2000 requests the cluster controller 270 to perform the blockage process on the storage cluster 200 (step 10030), and ends the processing (step 10050). Meanwhile, if the answer is NO, the event control mechanism 2000 requests the node controller 280 to perform the blockage process on the storage node 220 (step 10040), and stands by for event completion (step 5040).

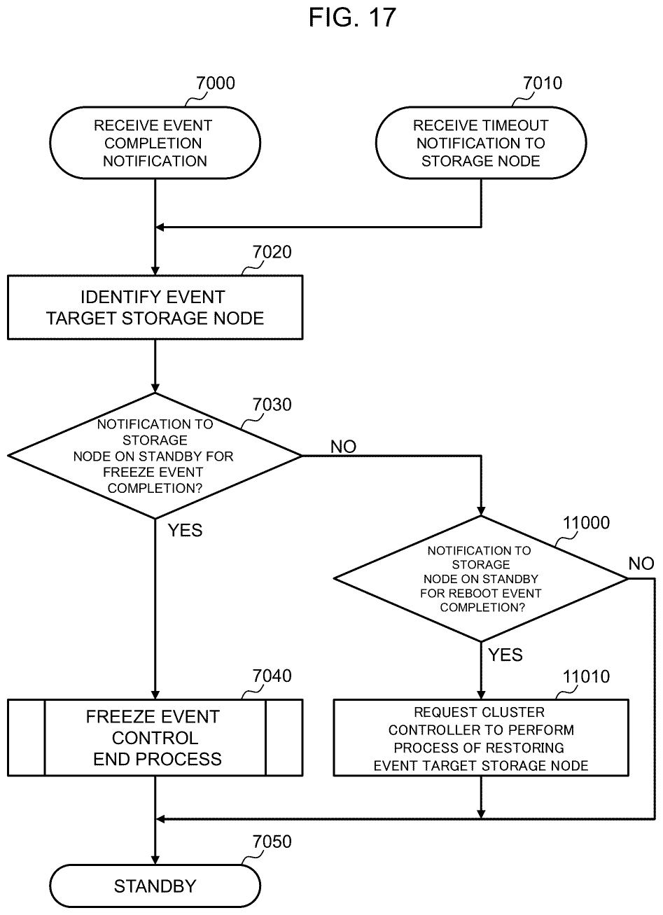

FIG. 17 is a flowchart illustrating the end of control exercised by the event control mechanism according to the second embodiment. Upon receiving the event completion notification 520 from the event monitoring mechanism 3000 (step 7000) or receiving the timeout notification 530 from the cluster controller 270 (step 7010), the event control mechanism 2000 starts to exercise control. Then, from the contents of the event data 510, the event control mechanism 2000 identifies the event target storage node 220 (step 7020).

Next, according to the contents of the received notification, the event control mechanism 2000 determines whether the notification is addressed to a storage node 220 that is standing by for the completion of a freeze event (step 7030). If the answer to the query in step 7030 is YES, the event control mechanism 2000 performs the freeze event control end process (step 7040) and goes into the standby state (step 7050). Meanwhile, if the answer is NO, the processing proceeds to step 11000.

In step 11000, the event control mechanism 2000 determines whether the notification is addressed to a storage node 220 that is standing by for the completion of a reboot event. If the answer to the query in step 11000 is YES, the event control mechanism 2000 requests the cluster controller 270 to perform the restoration process on the event target storage node 220 (step 11010) and goes into the standby state (step 7050). Meanwhile, if the answer is NO, the event control mechanism 2000 goes directly into the standby state (step 7050).

As described above, according to the event type and the information regarding the storage cluster 200, the second embodiment determines how to exercise control.

If the event type is a freeze event, as is the case with the first embodiment, the second embodiment extends the timeout period of the event target storage node, stops the issuance of asynchronous I/Os in the capacity group to which the event target storage node belongs, and stops the reception of I/Os, thereby preventing the storage node from being stopped.

If the event type is a reboot event, the second embodiment handles such a situation by determining whether to stop the storage node or the storage cluster. Therefore, the second embodiment makes it possible to safely stop the storage node and the storage cluster.

### Third Embodiment

A third embodiment of the present invention describes an enhancement of the method in which the maintenance not requiring a reboot as described in conjunction with the first embodiment is handled without stopping the storage nodes. The enhancement is to classify received I/Os when I/O reception is stopped in the frontend, and to continue processing only processable I/Os. It is assumed that the third embodiment is configured as depicted in FIGS. 1 to 6 and adapted as described in conjunction with the first and second embodiments to handle the maintenance not requiring a reboot.

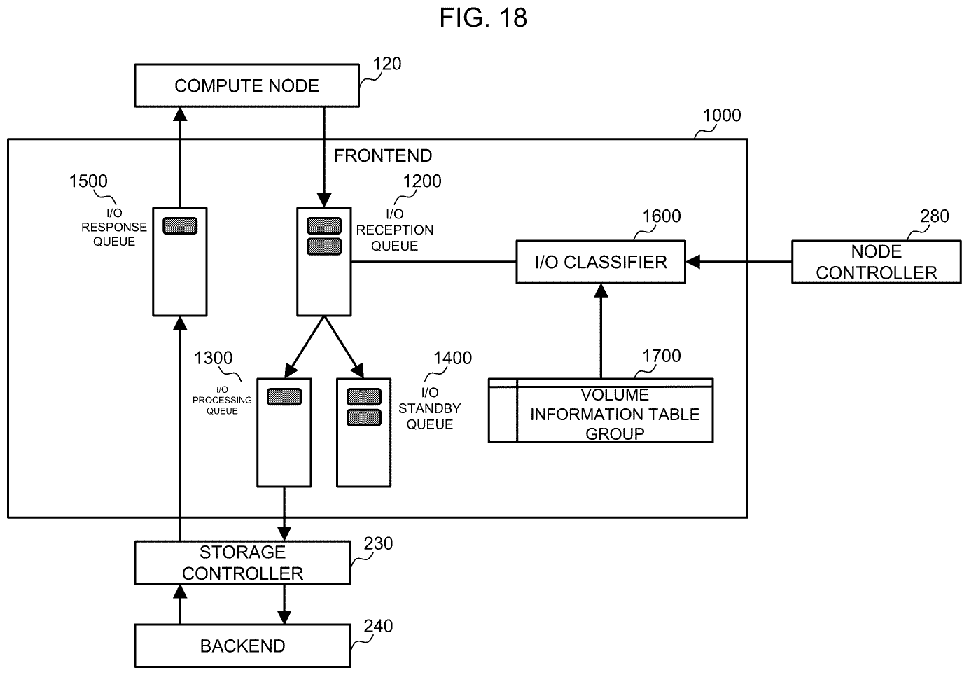

FIG. 18 is a diagram illustrating a configuration of the frontend according to the third embodiment. The frontend 1000 includes an I/O reception queue 1200, an I/O processing queue 1300, an I/O standby queue 1400, an I/O response queue 1500, an I/O classifier 1600, and a volume information table group 1700.

The I/O reception queue 1200 receives I/Os from the compute node 120 and holds the received I/Os. The I/O classifier 1600 classifies the I/Os held in the I/O reception queue 1200 into the I/O processing queue 1300 and the I/O standby queue 1400 according to the information in the volume information table group 1700. However, the classification is performed only when the stoppage of I/O reception in the frontend 1000 is requested by the node controller 280.

The I/O classifier 1600 classifies I/Os according to whether the I/Os can be processed without communication between the storage nodes. For example, in a case where an I/O is a write, data needs to be made redundant between the plurality of storage nodes 220. In such a case, therefore, inter-node communication is required. Consequently, the write is classified into the I/O standby queue 1400. Meanwhile, in a case where the I/O is a read, processing can be performed without inter-node communication as long as read data is stored in the local node. If the read data is not stored in the local node, inter-node communication is required. Thus, the read is classified into the I/O processing queue 1300 or the I/O standby queue 1400 depending on the location of the read data.

The I/O standby queue 1400 is a queue for holding I/Os without processing them. While I/O reception is stopped, the I/O standby queue 1400 holds I/Os that cannot be processed. When I/O reception resumes, the I/O standby queue 1400 passes the I/Os to the storage controller 230 for processing.

The I/O processing queue 1300 is a queue for processing I/Os. The I/Os held in the I/O processing queue 1300 are sequentially passed to the storage controller 230 for processing.

The I/O response queue 1500 is a queue for returning a response regarding an I/O to the compute node 120. The I/O is passed from the frontend 1000 to the storage controller 230 and then to the backend 240 for processing. When the processing is completed, the response is sequentially returned to the backend 240 and the storage controller 230 and then placed in the I/O response queue 1500 in the frontend 1000. The I/O passed to the I/O response queue 1500 is passed to the compute node 120 as the response.

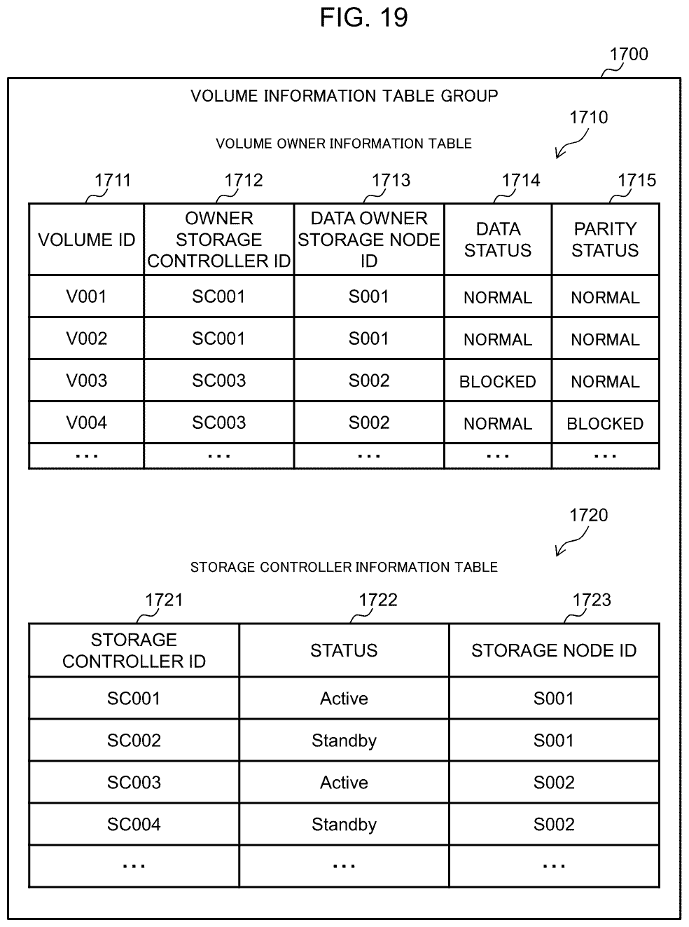

FIG. 19 illustrates the volume information table group. The volume information table group 1700 includes a volume owner information table 1710 and a storage controller information table 1720. The volume owner information table 1710 includes a volume ID 1711, an owner storage controller ID 1712, a data owner storage node ID 1713, a data status 1714, and a parity status 1715. The storage controller information table 1720 includes a storage controller ID 1721, a status 1722, and a storage node ID 1723.

The volume owner information table 1710 indicates the owner information regarding a volume. The volume is a virtual drive that the storage cluster 200 presents to the compute node 120. Each volume has the storage controller 230 which acts as an owner and is indicated by the owner storage controller ID 1712. I/Os to a volume are processed by the storage controller 230 acting as the owner of the volume. Further, each volume has the storage node 220 which acts as the owner of data and which stores the data on the volume. The data status 1714 indicates the status of the data on the volume. If the data status 1714 is “Normal,” reading and writing are possible. Meanwhile, if the data status 1714 is “Blocked,” reading and writing are not possible. The parity status 1715 indicates the status of parity of the data on the volume. If the parity status 1715 is “Normal,” reading and writing are possible. Meanwhile, if the parity status 1715 is “Blocked,” reading and writing are not possible.

The storage controller information table 1720 indicates information regarding the storage controller. The status 1722 indicates the status of the storage controller 230. If the status 1722 is Active, the storage controller 230 is operating normally. Meanwhile, if the status 1722 is Standby, the storage controller 230 is in the standby state, and is able to take over the processing performed by the Active storage controller when an abnormality occurs in the Active storage controller. The storage node ID 1723 indicates a storage node 220 to which the storage controller 230 belongs.

The following describes an example in which the I/O classifier 1600 classifies I/Os by using the volume information table group 1700. Upon receiving an attempt to read a certain volume, the frontend 1000 confirms whether an owner storage controller and a data owner storage node are the local nodes. Next, the frontend 1000 confirms that the data status 1714 is Normal. If all of these conditions are satisfied, it can be determined that the I/Os are able to access the data without performing inter-node communication.

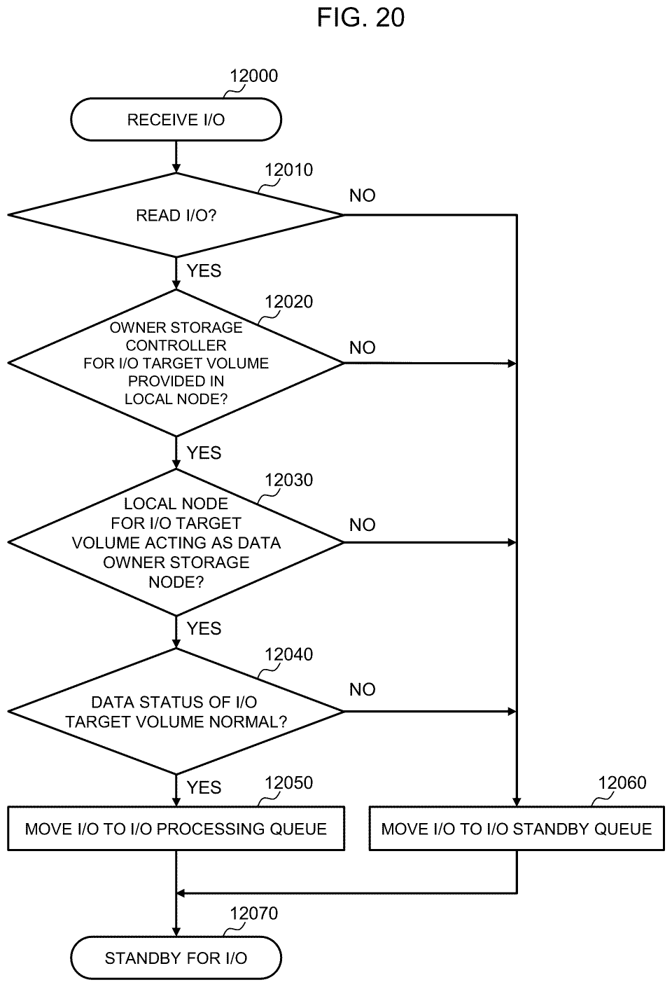

FIG. 20 is a flowchart illustrating I/O classification performed by the frontend according to the third embodiment. Upon receiving an I/O from the compute node 120, the frontend 1000 starts to exercise control (step 12000). Then, according to the contents of the I/O, the frontend 1000 determines whether the I/O is a read (step 12010). If the answer to the query in step 12010 is YES, the processing proceeds to step 12020. If the answer is NO, the processing proceeds to step 12060.

In step 12020, the frontend 1000 checks a volume targeted for I/O to determine whether there is an owner storage controller in the local node. If the answer to the query in step 12020 is YES, the processing proceeds to step 12030. If the answer is NO, the processing proceeds to step 12060. In step 12030, the frontend 1000 determines whether the local node is the data owner storage node for the volume targeted for I/O. If the answer to the query in step 12030 is YES, the processing proceeds to step 12040. If the answer is NO, the processing proceeds to step 12060. In step 12040, the frontend 1000 checks the volume targeted for I/O to determine whether the data status is Normal. If the answer to the query in step 12040 is YES, the frontend 1000 moves the I/O to the I/O processing queue 1300 (step 12050), and stands by for the next I/O (step 12070). If the answer is NO, the processing proceeds to step 12060. In step 12060, the frontend 1000 moves the I/O to the I/O standby queue 1400 and stands by for the next I/O (step 12070).

The I/O placed in the I/O processing queue 1300 is processed even in the event of a freeze at another node in the capacity group. The I/O placed in the I/O standby queue 1400 is processed after a freeze at another node in the capacity group is cleared.

As described above, the third embodiment makes it possible to process a processable I/O within one node even during the event of a freeze and thus prevents a decrease in availability.

As described above, the storage system includes the plurality of storage nodes 220, each having the arithmetic device (CPU 410) and the memory 420. Upon detecting a failure of a separate storage node in the storage system, the plurality of storage nodes 220 take over the failed storage node by failover. When a maintenance event occurs in the storage system, the plurality of storage nodes change, according to maintenance event information, the conditions for detecting the failure of a storage node related to the maintenance event, and restrict data input/output processing. The maintenance event information is the information regarding the maintenance event.

The above described configuration and operation enable the storage system to reduce the influence of maintenance events on performance.

Further, when the maintenance event occurs, the storage nodes extend the life/death monitoring timeout period as a condition for detecting the failure.

The extended life/death monitoring timeout period is longer than the duration of the maintenance event. As a result, when a maintenance event is to be performed, it is possible to avoid stopping a target storage node and prevent a decrease in the redundancy and availability of the storage system.

Furthermore, when the maintenance event occurs, the storage nodes stop data input/output processing related to a storage node involved in the maintenance event, and do not stop but execute data input/output processing not related to the storage node involved in the maintenance event.

Specifically, the storage nodes suspend a data input/output request received while the data input/output processing is stopped, store the suspended data input/output request in a memory, and process the suspended data input/output request after the end of the maintenance event.

Moreover, when the maintenance event occurs, the storage nodes handle the data input/output processing in such a manner as to stop write processing and stop read processing involving a separate storage, and do not stop but execute the read processing to be performed only by the local storage node. As a result, it is possible to reduce performance degradation in the execution of a maintenance event.

Additionally, when the maintenance event occurs, the storage nodes determine, according to the contents of the maintenance event, whether to change the conditions for detecting the failure or cause a separate storage node to take over a storage node involved in the maintenance event by failover.

Specifically, if the maintenance event does not include a reboot of the storage nodes, the storage nodes decide to change the conditions for detecting the failure when the maintenance event occurs, and if the maintenance event includes a reboot, the storage nodes decide to cause a separate storage node to take over a storage node involved in the maintenance event by failover.

As a result, it is possible to select an optimal operation for a maintenance event and reduce performance degradation in the execution of the maintenance event.

While the present invention has been described in terms of embodiments, it should be understood that the foregoing description of the present invention is illustrative and not restrictive. The scope of the present invention is not limited to the above-described embodiments. The present invention can be implemented in various other forms.

What is claimed is:

1. A storage system comprising:
a plurality of storage nodes, each having an arithmetic device and a memory;
wherein, upon detecting a failure of a separate storage node in the storage system, the plurality of storage nodes take over the failed storage node by failover, and,
when a maintenance event occurs in the storage system, the plurality of storage nodes change, according to maintenance event information, conditions for detecting the failure of a storage node related to the maintenance event, and restrict data input/output processing, the maintenance event information being information regarding the maintenance event.

2. The storage system according to claim 1,
wherein, when the maintenance event occurs, the storage nodes extend a life/death monitoring timeout period as a condition for detecting the failure.

3. The storage system according to claim 2,
wherein the extended life/death monitoring timeout period is longer than a duration of the maintenance event.

4. The storage system according to claim 1,
wherein, when the maintenance event occurs, the storage nodes stop data input/output processing related to a storage node involved in the maintenance event, and do not stop but execute data input/output processing not related to the storage node involved in the maintenance event.

5. The storage system according to claim 4,
wherein the storage nodes suspend a data input/output request received while the data input/output processing is stopped, store the suspended data input/output request in a memory, and process the suspended data input/output request after the end of the maintenance event.

6. The storage system according to claim 4,
wherein, when the maintenance event occurs, the storage nodes handle the data input/output processing in such a manner as to stop write processing and stop read processing involving a separate storage, and do not stop but execute the read processing to be performed only by the local storage node.

7. The storage system according to claim 1,
wherein, when the maintenance event occurs, the storage nodes determine, according to contents of the maintenance event, whether to change the conditions for detecting the failure or cause a separate storage node to take over a storage node involved in the maintenance event by failover.

8. The storage system according to claim 7,
wherein, when the maintenance event does not include a reboot of the storage nodes, the storage nodes decide to change the conditions for detecting the failure when the maintenance event occurs, and when the maintenance event includes a reboot, the storage nodes decide to cause a separate storage node to take over a storage node involved in the maintenance event by failover.

9. A storage system control method for controlling a storage system that includes a plurality of storage nodes, each having an arithmetic device and a memory, the storage system control method comprising:
when the plurality of storage nodes detect a failure of a separate storage node in the storage system, causing the plurality of storage nodes to take over the failed storage node by failover, and,
when a maintenance event occurs in the storage system, causing the plurality of storage nodes to change, according to maintenance event information, conditions for detecting the failure of a storage node related to the maintenance event, and restrict data input/output processing, the maintenance event information being information regarding the maintenance event.
